(19) United States
(12) Patent Application Publication
(10) Pub. No.: US 2017/0331274 A1
(43) Pub. Date: Nov. 16, 2017

(54) METHOD AND DEVICE FOR FAULT CLEARING IN ELECTRIC NETWORKS WITH RING-FEED-LOOPS

(71) Applicant: Dlaboratory Sweden AB, LUND (SE)

(72) Inventor: Magnus AKKE, LUND (SE)

(21) Appl. No.: 15/585,435

(22) Filed: May 3, 2017

(30) Foreign Application Priority Data
May 11, 2016 (SE) 1650635-4

(51) Int. Cl. H02H 3/16

(52) U.S. Cl. CPC H02H 3/165

(57) ABSTRACT

A method and a device for disconnection of faults in an electric network comprising a plurality of stations connected in a loop, comprising feeding the loop from at least two feeding points from a power source, earthing a neutral point of the electric network through an impedance, detecting earth faults in a directional earth fault protection in at least one first secondary substation provided with directional earth fault protection, disconnecting a detected earth fault by a load switching device in said at least one first secondary substation provided with directional earth fault protection, detecting fault currents arising from short circuits between two or more phases in an over-current protection of a second secondary substation, and opening said loop with a circuit breaker of said second secondary substation.

### TECHNICAL AREA

The invention presents a method and device for disconnection of faults in an electric network, which has several stations connected in a loop. In particular, the invention can be used for fault clearing in impedance earthed three phase electric network with ring-feed-loops.

### STATE OF THE ART

A secondary substation typically has one transformer and switching devices. Typically, three phase medium voltage, 10 kV or 20 kV, are transformed to three phase low voltage, 400 V, for distribution of electricity, to industry and household customers. Typically, the rated power for a transformer in a secondary substation range from 50 kVA up to 500 kVA.

A substation has typically one or more transformers, switching devices, relay protection and other control equipment. Typically, the voltage is transformed from a regional network, typically 130 kV, to medium voltage, 10 kV or 20 kV. Rated power for a transformer in a substation is typically from 2 MVA up to 50 MVA.

Three phase distribution networks are often called medium voltage network and the voltage ranges from 6 kV and up to 40 kV. The network distributes electricity with three separate conductors which have a voltage difference between the conductors (main voltages). Under normal operating conditions the three voltages are symmetrical in relation to a neutral point of the network. The voltage between a conductor and the neutral point is referred to as phase voltage. When using a Y-coupled transformer, the neutral point corresponds to a star-point of the transformer windings. If a delta coupled transformer is used in a substation, then it is possible to create the neutral point by using a separate transformer with Z-coupling.

The load current normally flows in the phases and returns by the other phase conductors. For distribution networks it is common practice to use over-current protection for faults between phases, and a separate function to provide protection against that one phase gets in contact with earth, referred to as an earth fault. The settings of various over-current protections in a distribution network are coordinated with the purpose to achieve selectivity, so that only the faulted section, or component, is disconnected from the network. Earth faults are by far the most common fault type, and according to “Protection Application Handbook”, 1WAT 710090-EN from ABB Switchgear, earth faults stands for 80% of all occurring faults. The earth fault current's magnitude depends strongly on the network's type of earthing, but also of line impedance and fault resistance. The type of earthing used for the distribution network's neutral point is very important to determine which principle that is suitable to use for earth fault protection.

There are different types of network earthing, some of which are:
Isolated (not connected) neutral point,
Coil earthed neutral point, i.e., resonance earthed by Petersen coil.
Network with earthed neutral point can be further divided into the two sub-categories; efficiently earthed network, and non-efficiently earthed network.
   American standard ANSI/IEEE 141 1986, gives the following alternatives for system earthing:
Stable earthed (without deliberate impedance in the neutral point);
Coil earthing;
Resistance earting with either low or high resistance;
Isolated neutral point.
   Given the presented alternatives, it is possible to distinguish between the different system earthing which are discussed below.

In the publication “Network Protection and Automation Guide, Alstom Grid, ISBN 978-09568678-0 3”, it is stated that directional earth fault protection is suitable for the following application areas.
Coil earthed network;
Isolated neutral point;
In combination with directional over-current protection;
To increase the sensitivity to detect high resistive earth faults.
   A more detailed discussion of various aspects on earth fault protection in coil earthed networks is given in the Swedish Patent SE536143.

On the market, there are many types of switching devices which can be used in electric distribution network to connect, conduct and disrupt (disconnect) the current during normal operation, or at specified abnormal conditions, such as short circuits. Some examples of used switching devices are, load switch, disconnector, load disconnector, fused load disconnector, and circuit breaker. They all have different rated data for breaking capacity and operation time, which makes them suitable for different tasks in the network. The price tag of the switching device is to a large extent determined by its rated data. Short operation time together with high breaking capacity implies a higher price. This explains why a circuit breaker with operation time around 20-60 ms and breaking capacity up to 20 kA, is a relatively expensive component for use in a distribution network. Switching devices, such as a load disconnector, with a breaking capacity limited to load current, will cost significantly less. Therefore, to make cost-efficient design improvements in distribution networks, it is very favorable to use low cost load disconnectors instead of circuit breakers.

In many countries, it is common to operate distribution network with radial feeders. A local distribution network is often fed from substation that transforms 130 kV to 10 kV (or 20 kV) and has several outgoing feeders. Normally, a feeder has one circuit breaker and an associated relay protection. Circuit breakers are expensive components. Considering the turn-over from a normal size Swedish, or international, distribution network, it is hard to economically justify more than one circuit breaker per feeder. Since each feeder only connect to one voltage source, it has become practice to use notations analog to water flows. It is common to say that a feeder has one upstream end and one downstream end. At normal operation, the upstream end is connected to the voltage source in the feeding substation, and the load is located downstream on the feeder.

In many countries, for example in Sweden, it is assumed that distribution network can have radial feeders only. Therefore, distribution networks and relay protections have been design in accordance with this ruling principle. Almost always the relay protection for the feeder is located together with the circuit breaker in the substation. This means that all types of electric fault, both short circuits and earth faults, are disconnected by the circuit breaker in the feeding end, which results in disconnection of all customers connected to the radial. Remote control can be used to sectionalize and locate the faulted feeder section. At best there are load disconnectors, which can be remotely controlled to isolate the faulted section. Technology for remote control of switching devices is commercially available, for example by the company TECHINOVA.

The faulted line section is usually identified by an iterative procedure where each line section is isolated and then the feeder is re-energized by the circuit breaker at the feeding end. If the fault disappears, then it is assumed that the fault is at the disconnected section. The procedure is time consuming and causes inconvenience for customers which can be disconnected and then re-connected multiple times, before the faulted line section is located. The duration of the power failure is determined by the time it takes to locate the fault, isolate it and reconfigure the network so that customers down streams of the fault can be fed from an alternative route of the network.

Some improvements of the relay protection system have been proposed in the literature. One example is described in European patent EP2738898B1 and US published patent application No. 2014/0098450 A1. Still these improvements do not address the basic problem with the radial structure of feeders, which still means that all customers downstream of the fault will have power interruptions. Improvements as suggested in European patent EP2738898B1, does not solve the underlying problem with a radial feeder, since still, in average half the customers will be disconnected from their supply if there is a fault on the feeder.

The total interruption time is also affected by the time it takes to switch and reconfigure the network to restore the power supply by an alternative feeding route.

To its nature, a radial feeder is very sensitive for disturbances since one single fault always will cause disconnection of customers. One remedial action that has been extensively used in the Swedish distribution network is to replace overhead lines with cables. But this has been a very costly alternative since cables and their installation are much more expensive than overhead lines. For example E.On Elnät Sweden, has information on their homepage (https://www.eon.se/om-e-on/verksamhetsomraden/elnaet/historienom-krafttag.html) which claim that the cost has been 12 000 Million SEK, to replace 17 000 km overhead line with cable. This corresponds to 700 000 SEK=70 000 EUR per km cable. For this investment, it has been possible to reduce the interruption time by 60%.

Another arrangement to reduce the total interruption time, is to make the process to identify the faulted feeder section more time efficient, so that the disconnected customers will have their power supply back a little bit quicker. The company PROTROL has a product which can be used directly identify the faulted feeder section.

The time it takes to make the necessary switching and reconfiguration of the network can be reduced by using remotely controlled load disconnectors. In some older networks, the switching devices can only be manually operated, and this requires extensive transportation between different geographical locations in the network, which might prolong the power interruption by several hours. Another possibility to reduce the total interruption time is to automatize the procedure of sectionalizing the feeder, test energization and making network reconfigurations. Commercially available products can be used to automatize the restoration process.

One alternative solution to radial feeders in distribution network, is to use ring-feed-loops. In particular for densely populated areas with high demands on reliability, it can be economically justified to build a distribution network with ring-feed-loops. Such loops have the following properties:
Each secondary substation needs two circuit breakers with relay protection;
Directional earth fault protection and directional over-current protection are used to selectively disconnect the faulted feeder section;
Selectivity is achieved by using several different time steps

A ring-feed-loop with coordinated relay protection results in these main advantages.
The power supply to all customers is maintained even if there is a fault on one feeder section.
The relay protection system operates without any communication of signals between secondary substations.

Ring-feed-loops also has some disadvantages, which are:
Each secondary substation needs two circuit breakers with directional relay protection which implies high costs for investment and maintenance;
Engineering work is needed to coordinate and maintain the relay settings which are needed to achieve selectivity, especially for alternations in the ring-feed-loop;
Most components in an electric network have thermal restrictions which put restrictions on the longest permissible time fault clearing, so that components are not over-heated or damaged. Time margins are also needed to achieve selectivity between the different secondary substations and the feeding substation. Together these restrictions put an upper limit on the number of secondary substations which can be included in the ring-feed-loop.
Many countries have authorities that regulate and state requirements on network owners and operators. The Swedish Energy Markets Inspectorate issues regulations on voltage quality, c.f. EIFS 2013. This regulation states maximal allowed time for different short time voltage drops. For distribution network with voltage below 45 kV, 6§, table 3, must be complied with. The regulation states that if the voltage drops below 40% of normal operating voltage, the maximum allowed time duration is 1.0 second. The implication is that all short circuit protection in the ring-feed-loop must have a fault clearing time which is less than 1.0 second.
Hence the maximal fault clearing time together with selectivity requirements, will limit the number of available time settings in the selectivity plan, and implicitly will limit the number of secondary substations which can be include in the ring-feed-loop.

It is important to note, that for networks where the earth fault current is limited to normal load currents, the regulation of voltage drop is not a limiting factor, as long as earth fault are concerned. When the earth fault current is limited to normal load current, then the thermal limitations are of less importance, which implies much less restriction on longer fault clearing times.

The main objective with the invention is to propose a solution which gives better possibilities to build reliable, and also cost effective distribution networks, which will significantly reduce customer interruption time in case of electrical faults in the network.

### SUMMARY OF INVENTION

The invention relates to a method and device for disconnection of faults in an electric network, which has several secondary substations connected in a closed loop, i.e. a ring-feed-loop. Specifically, the invention aims to be used for fault clearing in impedance earthed distribution network, which have ring-feed-loops.

Many distribution networks use impedance earthing which limits the earth fault current's magnitude to values below normal load current. The invention is most useful for impedance earthed network, which make it possible to use of simple low cost switching devices to disconnect the earth fault current.

In various embodiments a suggested relay protection system has a function which blocks operation of the switching device for those cases when the fault current exceeds the rated data of the switching device, for example at two phase short circuit with earth connection.

The invention makes it possible to use longer time settings, since the magnitude of the earth fault current is limited to load current, which implies less thermal restrictions. Another benefit with a limited current magnitude is that it does not cause any voltage drops which violate authority regulations on voltage quality. Since around 80% of all faults in distribution networks are earth faults, a large part of the benefits with a ring feed loop will be achieved to a fraction of the cost for a complete fault clearing system in accordance with previous state-of-the-art for a ring-feed-loop.

### BRIEF DESCRIPTION OF FIGURES

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1a-FIG. 1e show the basic components of a distribution network,

FIG. 2 shows a prior art distribution network with impedance earthed neutral point and radial feeders,

FIG. 3 shows a prior art distribution network with a prior art relay protection in a ring-feed-loop,

FIG. 4 illustrates schematically a first implementation of a distribution network with ring-feed-loop in accordance with the invention,

FIG. 5 illustrates schematically a second implementation of a distribution network with ring-feed-loop in accordance with the invention

### DETAILED DESCRIPTION

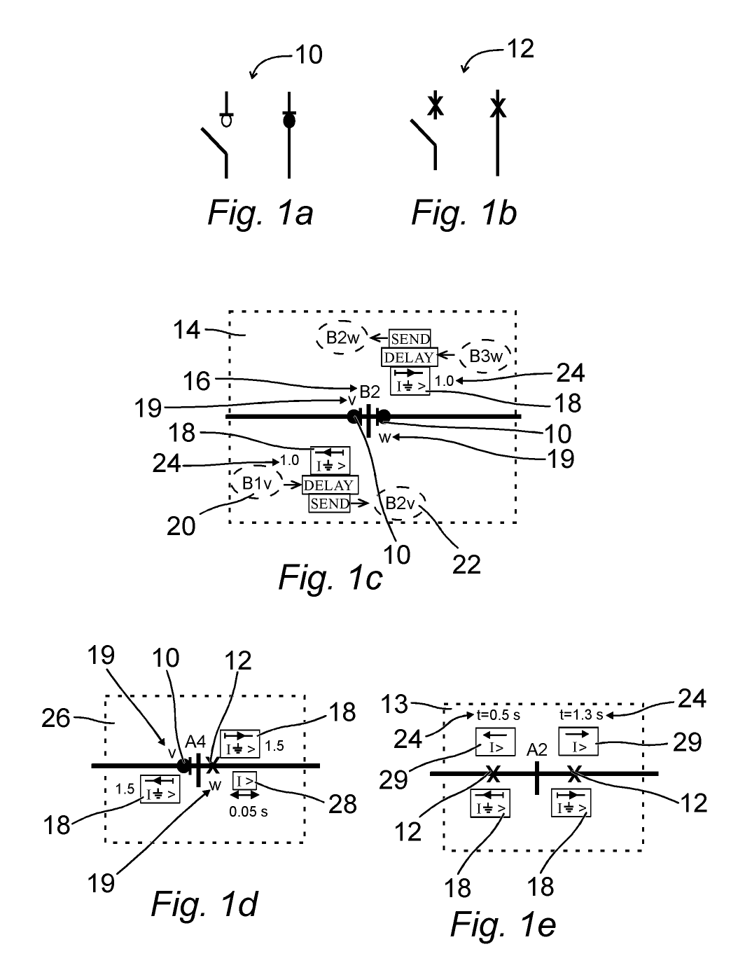

FIG. 1a-1e show some of the components which are used in an electric distribution network. FIG. 1a shows to the left a load switching device 10, in open, i.e., disconnected state (OFF). To the right is shown a load disconnector in closed, i.e., connected state (ON). The term “load switching devices” is a general terms which refers to all switching devices which can interrupt normal load current, such as load switches, and load switches with disconnector, and load switches with fuses. In the same way, FIG. 1b shows a circuit breaker 12. To the left in 12, the circuit breaker is shown in disconnected (OFF) state, and to the right the circuit breaker 12 is shown in connected (ON) state.

Depending on the context, the general term station can be used either for a secondary substation or a substation.

A secondary substation typically has one transformer and switching devices, typically load disconnectors. Normally, three phase medium voltage, 6 kV, 10 kV or 20 kV, is transformed to three phase low voltage, 400 V, which feeds customers. Typically, the rated power for a transformer in a secondary substation ranges from 50 kVA up to 500 kVA.

A substation typically has one or more transformers, several switching devices, typically circuit breakers, with relay protection and other control equipment. Typically, the voltage is transformed from the regional network, normally 130 kV, to medium voltage, 6 kV, 10 kV or 20 kV. The rated power for a transformer in a substation typically is in the range from 2 MVA up to 50 MVA.

Relay protection, or a relay protection system, is a device which detects fault, or other abnormal conditions, in a distribution network and activates disconnection so that the network returns to normal operating condition. The relay protection should also give signals and indications that typically are signaled locally, but also transmitted to the network operation center.

In general terms, relay protection refers to a device, protection or equipment intended to protect an object, system or function. Sometimes the terms protection equipment, or relay protection system can be used. In other words, a relay protection system consists of one or a plurality of protection devices and other equipment which are needed to fulfill specified protection functions. A rely protection system can include one or many protection devices, measurement transformers, connections, trip circuits, auxiliary power, and communication. Depending on the principle for the relay protection system, it might include protection devices in one end, or several ends, of the protected area, or object.

Directional protection refers to a relay protection which only operates for fault located in a certain direction seen from the relay location. A directional relay is a measuring relay intended to detect faults with reference to a certain point in the network.

Over-current protection is a protection device which is intended to operate if the current exceed a preset value. The term “time delay” refers to a function which deliberately delays the relay's operation. In this document “time setting” means to set a time delay. Earth fault protection is a relay device which is intended to detect earth fault in a power system.

FIG. 1c shows a station 14 which is a secondary substation. The station 14 also includes several different control and protection devices. The station 14 also includes two load breaking switching devices 10 typically load disconnectors, in connected, or ON-state. Each station has a name and a unique identity 16. The station in FIG. 1c has the identity B2. Both load-breaking switching devices 10 have directional earth fault protection, which is indicated by the symbol at 18.

If an incoming signal 20 with a signal identity B1v is received, then the time setting is increased (DELAY) with a pre-set value for this directional earth fault protection. In general, the signal identity consists of the stations identity 16 together with the identity 19 for the specific switching devices which sends the signal. If the directional the earth fault protection detects a fault, an outgoing signal 22, with the signal identity B2v, is transmitted (SEND) to a neighboring station. The signal identity gives the stations unique identity, here B2, combined with the identity of the switching devices, here v. Corresponding notations and symbols are used for the switching device with identity w. Each switching device has a relay protection with time settings, as shown by the arrows at 24. For the switching device at w the time setting is 1.0 seconds. The same time setting is used for the switching devices at v.

An alternative station 26 is shown in FIG. 1d. This station has the notation A4 and includes one load disconnector 10 and one circuit breaker 12. The circuit breaker has an identity 19 which is w, and an associated relay protection which is a directional earth fault protection 18 and a non-directional over-current protection 28. The load disconnector 10 has the identity 19 which is v, and associated relay protection which is directional earth fault protection 18.

FIG. 1e shows an alternative station 13 with circuit breakers. This station has the notations A2 and includes two circuit breakers 12. Each circuit breaker has associated relay protection which includes a directional earth fault protection 18 and directional over-current protection 29.

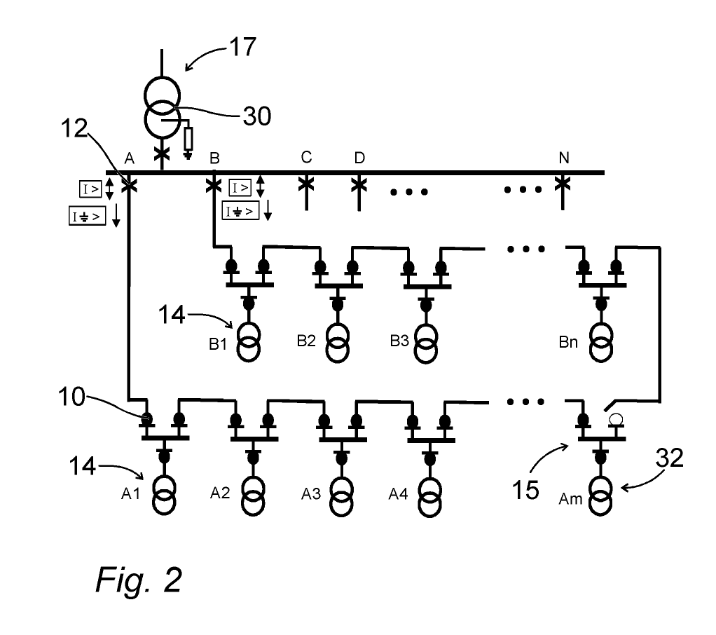

FIG. 2 shows a typical network that is commonly used in many countries, for example Sweden. The distribution network is fed by a transformer 30 in a substation 17. The transformer transformers the higher voltage level from a region network, such as 130 kV, down to medium voltage for example 10 kV or 20 kV. A ring-feed-loop can be created by connecting the two radial feeders at the remote line end where the two feeders often meet in a common secondary substation 15. For the network shown in FIG. 2, the two feeders meet at the common secondary substation 15 with notation Am. This secondary substation normally is used when there is a need to create an alternative feeding route, typically when downstream loads need to be reserve feed. Each feeder uses a circuit breaker 12, and each secondary substation 14, with the identities A1-Am and B1-Bn, use load disconnectors 10. A secondary substation also includes a network transformer 32, which transforms the medium voltage, 10 kV or 20 kV, down to low voltage, 400 V, which feeds the normal customers such as industry or households.

It is common that two feeders are paired into something referred to as “an-open-loop”. The name implies that two feeders are terminated in the same secondary substation, but only one of the feeders is connected to the secondary substation, and the other feeder is not connected, but acts as a spare feeder.

If one section of the feeder needs to be disconnected due to a permanent fault, for example a broken cable, then loads located downstream of the fault location, can have a fallback feed from the other feeder. For a secondary substation with load, there is one normal feeding route and one alternative feeding route which can be used after network has been altered by switching operations.

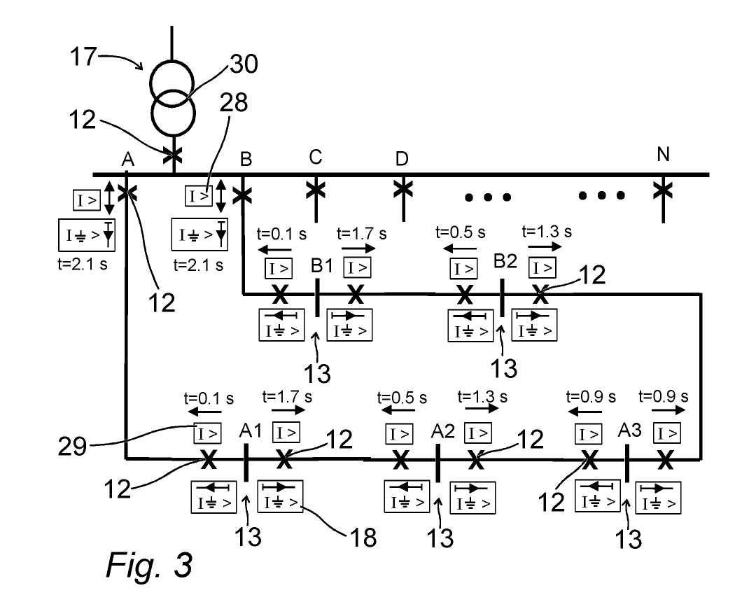

FIG. 3 shows a well-known distribution network with relay protection and signal communication for switching devices. In distribution network, radio signals normally are used to communicate signals for remote control of switching devices. The distribution network in FIG. 3 includes a ring-feedloop. The distribution network is fed by a transformer 30 in a substation 17. The transformer transforms the higher voltage from the regional network such as 130 kV down to medium voltage such as 10 kV or 20 kV. Circuit breakers 12 are used at the two feeding points at the beginning of the loop, and also circuit breakers 12 are used on each side of each secondary substation 14. The secondary substations have the identities A1-A3, and B1 and B2, respectively. Each switching device use directional over-current protection 29 with time setting.

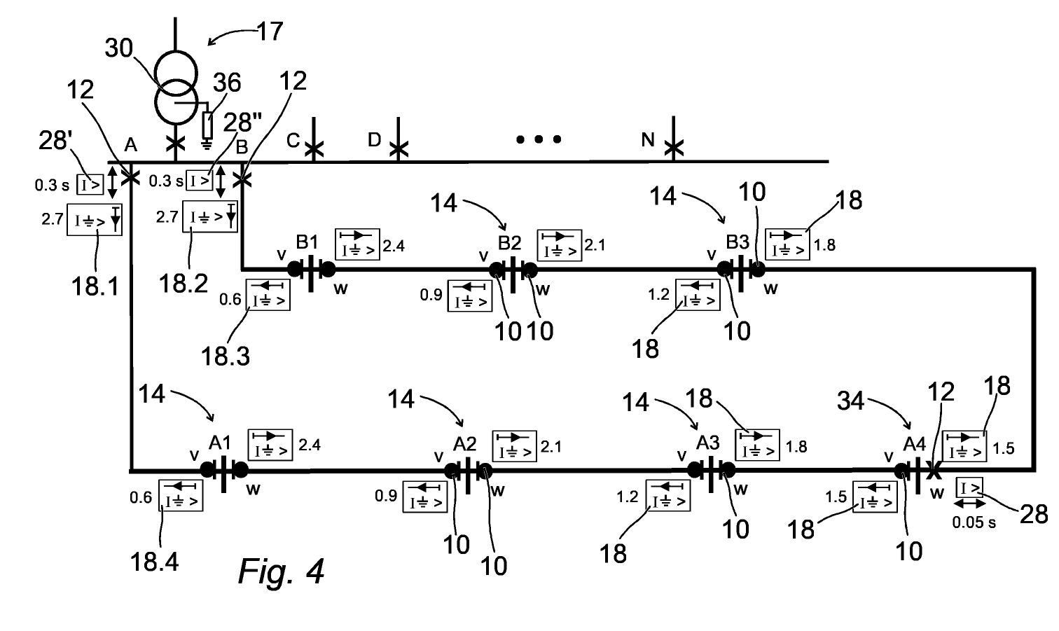

FIG. 4 shows the electric network with a ring-feed-loop in accordance with the invention, with notations as described in the figures above. The relay protection together with different switching devices use different time settings to achieve selectivity, and the relay protection system does not need any communication of relay signals. Each secondary substation 14 has two directional earth fault protections 18 and two load disconnectors 10 with breaking capacity up to load currents. Typical switching devices in a secondary substation can be load disconnectors, or different type of load switches. The ring-feed-loop is created by pairing feeders which have previously been operated as an open-loop, and have served as alternative feeding routes for each other.

The electric network in FIG. 4 is fed by a transformer 30. The network's neutral point is earthed by impedance 36. Normally, two feeding points or feeders A and B terminate in a common secondary substation, as shown in FIG. 2. FIG. 4 shows a ring-feed-loop comprising a modified secondary substation 34 with the identity A4. In the modified secondary substation 34, a new circuit breaker 12, identity w, need to be installed, together with non-directional over-current protection 28 and directional earth fault protection 18. It also includes a load disconnector 10 with the identity v with associated directional earth fault protection 18. The non-directional over-current protection 28 at the modified secondary substation 34 has the shortest time setting, in the example shown only 0.05 seconds. This means that the associated circuit breaker 12, with identity w, will initially open the loop, if a short circuit should occur. Thereafter the fault is disconnected by the non-directional over-current protection at the in-feeding end of the line.

FIG. 4 also illustrates an example on how to set the time delay of the protection to achieve time selectivity so that the protection closes to the fault trips firstly. Time selectivity for the over-current protection is needed between the protection in the feeding substation 17 forming a power source and the over-current protection in the secondary substation where both feeders terminate. This implies that only two selective time steps are needed, in comparison with existing state-of-the-art as illustrated in FIG. 3, which requires one additional time setting per secondary substation. With the proposed invention, the fault clearing times for short circuits can be kept short. The time setting for directional earth fault protections need to achieve selectivity between all secondary substations which are connected to the ring-feed-loop. Therefore, the directional earth fault protections need several different time settings which need to be coordinated to achieve selectivity. In the embodiment shown in FIG. 4, a time difference of 0.3 seconds is used between neighboring stations. The longest time delay is 2.7 seconds and this setting is used for the directional earth fault protection 18.1 at the feeder point A, and also for the earth fault protection 18.2 at feeder point B. The shortest time delay for the directional the earth fault protections 18 is 0.6 seconds and is used for the directional the earth fault protection 18.3 at switching devices v in secondary substation B1, and for the directional the earth fault protection 18.4 at switching devices v, in secondary substation A1. These settings make it possible to use totally eight different time delays, namely 0.6, 0.9, 1.2, 1.5, 1.8, 2.1, 2.4, 2.7 seconds. The longest time delay is used where feeders A and B start and connect to the substation 17. The remaining seven time delays are used to include an equal number of secondary substations in the ring-feedloop.

The electric network's neutral point is earthed by the impedance 36, which is selected for limiting the earth fault current to below the networks nominal load current. Hence a single earth fault will always create a fault current with a magnitude that is less than the nominal load current of the network.

Contrary to prior art fault clearing systems for ring-feed-loops in distribution networks, only one secondary substation, as illustrated in FIG. 4, needs to be modified. Only the secondary substation 34, need to use one circuit breaker 12. The modified secondary substation 34 is also equipped with one load disconnector 10. All other secondary substations in the ring-feedloop can use simpler, less expensive switching devices with rated current limited to load current, for example load disconnectors 10. Also selectivity is achieved without any needs to communicate relay signals between stations.

The invention illustrated in FIG. 4 will significantly improve the reliability of a distribution network, and this benefit is achieved at a moderate additional cost. An electric distribution network which is designed in accordance with the invention should be a superior investment alternative as compared to investments based on prior art technique.

In the electric network shown in FIG. 4 the over-current protections are not selective between the secondary substations. Selectivity is only achieved between the over-current protection in the feeding substation and the over-current protection in the common terminating secondary substation. This means that for short circuits, the over-current protection in the terminating line end will trip in a first step to open the loop. The first tripping result in two separate radials, where the faulted feeder will be disconnected by the protection in the feeding substation. For the network shown in FIG. 4 the second part of the fault clearing will be handled either by the non-directional over-current protection 28′ at feeder A or by the non-directional over-current protection 28″ at feeder B.

It should be noted that the number of secondary substations that can be included in a ring-feed-loop is limited by the number of available time steps in the used selectivity plan, which in turn is governed by the time margins needed and maximal allowed fault clearing time for earth faults. Therefore, necessary to provide and maintain a selectivity plan. This is particularly important if new secondary substations need to be introduced into the ring-feed-loop.

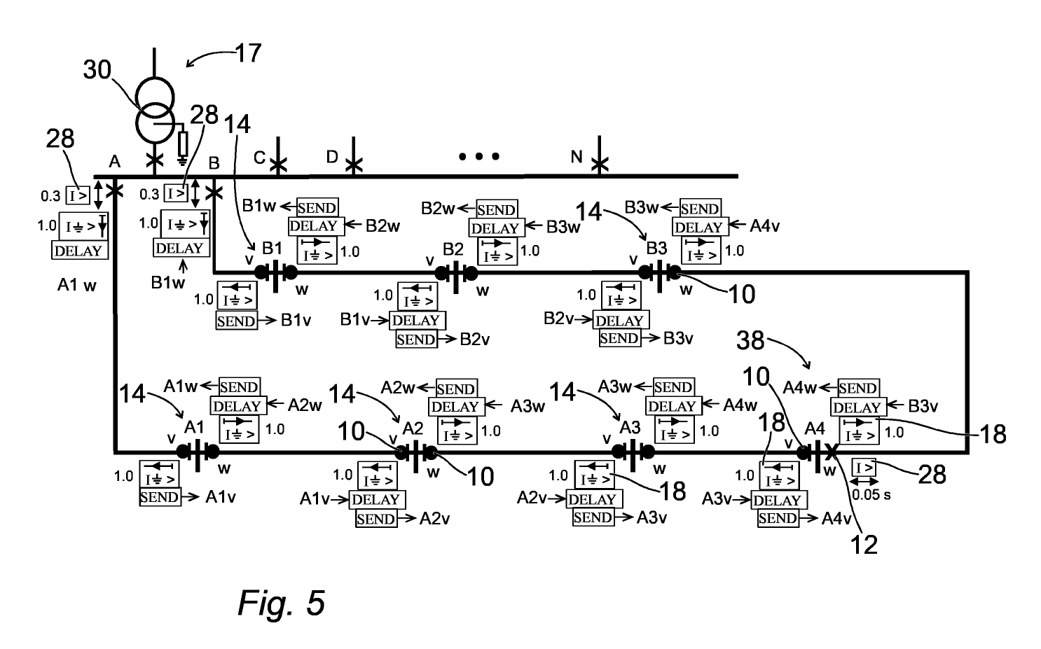

FIG. 5 shows an alternative embodiment of a network with ring-feed-loops in accordance with the invention. In this embodiment, the ring-feed-loop uses signal communication between neighboring secondary substations. The same basic notations as above have been used. Signal communication between neighboring secondary substations is used to achieve time selectivity between the directional earth fault protections. Preferably radio communication is used between the secondary substations. For example, a radio system in accordance with ETSI standard EN300 113 can be used. A commercially available radio system is available from TECHINOVA AB. The radio system operates within the frequency range 138-151 MHz and 420-470 MHz. It is also possible to use other radio standards, and also mobile networks such as GSM, GPRS, 4G and similar. Standard components for mobile communication can be used. Since the neighboring secondary substations often are located in relatively close proximity to each other the range requirements are modest, typically less than 1 km. Since only logical signals need to be communicated, the demand on bandwidth is very low. In summary, the technical requirements on signal communication are very low.

All secondary substations 14 in the ring-feed-loop in FIG. 5, except for one, have two directional earth fault protections 18 together with load disconnectors 10, with a breaking capacity that is limited to disrupt normal load currents. The ring-feed-loop shown in FIG. 5 is created by pairing two feeders that can operate as a reserve for each other. It is common that two feeders which are reserve to each other are terminated in a common secondary substation 38, as illustrated by the modified secondary substation 34 in FIG. 4. In the common secondary substation 38 there needs to be installed one circuit breaker 12 together with non-directional over-current protection 28, and directional earth fault protection 18.

FIG. 5 illustrates the principle for signal communication which is used for the directional the earth fault protection. The signal communication is between neighboring secondary substations only. The over-current protection needs to be coordinated in two time steps to achieve selectivity between the feeders in the feeding substation and the over-current protection in the terminating secondary substation 38. This implies that only two time selective steps are need for the over-current protection. For the implementation shown in FIG. 5, the time setting for the non-directional over-current protection 28 at feeders A and B is set to 0.3 seconds. In the terminating common secondary substation 38, the time setting for the non-directional over-current protection 28 is 0.05 seconds. The advantage with two time steps only is that it makes it possible to get a short fault clearing time for short circuits.

Each secondary substation needs two directional earth fault protection with switching devices, and in addition also equipment for signal communication of logical relay signals between neighboring secondary substations is needed. FIG. 5 shows an example of time settings of directional earth fault protection. All directional earth fault protection 18 have the same default setting of 1 second. If any directional earth fault protection 18 detects a fault in forward direction, then a boolean (true or false) signal is sent (transmitted) to the neighboring secondary substation in relay's reverse (backward) direction. With restriction to single earth faults, only one of the two directional earth fault protections in a secondary substation can see the fault in forward direction. This implies that in each secondary substation only one signal needs to be transmitted. The transmitted signal should contain a unique identity for the directional earth fault protection that has detected a fault in forward direction.

Each secondary substation also needs to be able to receive signals from neighboring secondary substations. If a secondary substation has transmitted a signal for start of directional earth fault protection, and if this signal is received in the neighboring secondary substation, then an additional time delay is added for the directional earth fault protection in the receiving secondary substation. The protection that is delayed is the one operating in the same direction as the sending earth fault protection in the neighboring station. A typical extra time delay can be 0.8 seconds. This implies that only the directional earth fault protection that is closest to the fault will keep the default-time setting of 1.0 second, and all other directional earth fault protections that detect the fault, will increase the default time setting with 0.8 second. This means that the total fault clearing time will be 1.0 seconds if the earth fault is detected simultaneously from side A and side B. However, the total fault clearing time will be 2.0 seconds if one of the sides, either A or B, detects the fault not until after the tripping of the other side.

FIG. 5 schematically shows the principle for signal communication, where the blocks with the notation SEND shows the signal which is transmitted. The notation DELAY shows that if this signal is received, then an extra time delay is added to the default time delay of the directional earth fault protection. The additional time delay can typically be 0.8 seconds. Also this implementation, gives significant advantages compared to previous prior art investment alternatives. The ring-feed-loop only needs one additional circuit breaker 12. The circuit breaker is used in the common secondary substation 38 which terminates feeders. In all other secondary substations 14, simpler low-cost switching devices, such as load disconnectors 10 can be used.

One advantage of using the proposed invention with signal communication is that there exist no limitations based on multiple time steps to achieve time selectivity. Therefore, the number of secondary substations that can be included in the ring-feed-loop can be selected without considering the number of available time steps. The directional earth fault protection 18 which is used can be have uniform settings, which to a large extent simplifies engineering and installations work. The uniform settings also simplifies future modification and extension with new secondary substations.

If short circuits occur, selectivity is not achieved between the secondary substations. Selectivity is only achieved between the over-current protection in the feeding end at the substation, and the over-current protection in the terminating common secondary substation 38. This means that for short circuits, firstly the ring-feed-loop is split into two separate radials, and then the faulted radial will trip.

While certain illustrative embodiments of the invention have been described in particularity, it will be understood that various other modifications will be readily apparent to those skilled in the art. Accordingly, it is not intended that the scope of the claims appended hereto be limited to the description set forth herein but rather that the claims be construed as encompassing all equivalents of the present invention which are apparent to those skilled in the art to which the invention pertains.

1. A method for disconnection of faults in an electric network comprising a plurality of stations connected in a loop, wherein
feeding the loop from at least two feeding points from a power source,
earthing a neutral point of the electric network through an impedance,
detecting earth faults in a directional earth fault protection in at least one first secondary substation provided with directional earth fault protection,
disconnecting a detected earth fault by a load switching device in said at least one first secondary substation provided with directional earth fault protection,
detecting fault currents arising from short circuits between two or more phases in an over-current protection of a second secondary substation, and
opening said loop with a circuit breaker of said second secondary substation

2. A method in accordance with claim 1, also comprising providing directional earth fault protections of said at least one first secondary substation with different time settings.

3. A method in accordance with claim 2, wherein directional earth fault protections of said at least one first secondary substation are set with a longest time setting at the secondary substation arranged closest to a feeder point and with step wise shorter time settings along the loop.

4. A method in accordance with claim 1, wherein over-current protection of said second secondary substation is provided with a shorter time setting than time settings of other over-current protections in the loop.

5. A method in accordance with claim 4, also comprising providing the loop at each respective feeding point with circuit breakers and over-current protections with longer time settings than time settings at said second secondary substation.

6. A method in accordance with claim 2, also comprising transmitting in a backward direction a delay signal from a directional earth fault protection to a directional earth fault protection of an adjacent first secondary substation when detecting an earth fault in a forward direction.

7. A method in accordance with claim 1, also comprising transmitting said delay signal through wireless communication.

8. A device for disconnection of faults in an electric network comprising a plurality of stations connected in a loop, wherein
said loop is connected to a power source in at least to feeding points,
a neutral point of the electric network is connected to earth through an impedance
at least one first secondary substation is provided with a directional earth fault protection for detecting earth faults,
said at least one first secondary substation is provided with a load switching device for disconnecting a detected earth fault,
a second secondary substation is provided with an over-current protection for detecting fault currents arising from short circuits between two or more phases, and
said second secondary substation is provided with a circuit breaker for opening said loop after detecting said fault currents.

9. A device in accordance with claim 8, wherein said directional earth fault protections of said first secondary substations are provided with different time settings.

10. A device in accordance with claim 8, wherein said directional earth fault protection of said second secondary substation is provided with a time setting that is shorter than time settings of other over-current protections of the loop.

11. A device in accordance with claim 8, wherein circuit breakers and over-current protections with longer time settings than time settings at said second secondary substation are provided at each respective feeding point of the loop.
